(19) United States
(12) Patent Application Publication
(10) Pub. No.: US 2006/0108880 A1
(43) Pub. Date: May 25, 2006

(54) Linear compressor

(75) Inventors: Jong Koo Lee, Kyungki-do (KR); Gye Young Song, Kyungki-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/995,298

(22) Filed: Nov. 24, 2004

(51) Int. Cl. H02K 41/00; F04B 49/06; F04B 17/00; F04B 35/04; F04B 17/04

(52) U.S. Cl. 310/14; 417/415; 417/417; 417/44.1; 310/12; 310/15; 310/36

(57) ABSTRACT

Disclosed herein is a linear compressor. The linear compressor comprises a cooling channel disposed in contact with a bobbin on which a coil is wound, and a cooling fluid supply unit to supply a cooling fluid to the cooling channel such that the bobbin and the coil are cooled by means of the cooling fluid. Consequently, the coil is prevented from overheating, whereby compression efficiency of the linear compressor is effectively improved, and service life of the linear compressor is effectively increased.

### BACKGROUND OF THE INVENTION

1. Field of the Invention

The present invention relates to a linear compressor with a linear motor, and more particularly to a linear compressor that is capable of cooling a linear motor.

2. Description of the Related Art

Generally, a linear compressor is constructed such that a linear driving force from a linear motor is transmitted to a piston, which is linearly reciprocated in a cylinder, whereby a fluid, such as a refrigerant gas, is introduced into the cylinder, compressed in the cylinder, and discharged from the cylinder.

The linear motor comprises a stator and a mover.

The stator comprises: an outer core; an inner core disposed such that the inner core is spaced apart from the outer core by a prescribed distance; a bobbin attached to the outer core; and a coil wound on the bobbin.

The mover comprises: a magnet linearly movable forward and backward by means of a magnetic force generated around the coil; and a magnet frame fixedly attached to the piston. The magnet being fixed to the magnet frame such that the linear forward and backward movement of the magnet can be transmitted to the piston.

When electric voltage is applied to the coil of the conventional linear compressor with the above-stated construction, a magnetic field is created around the coil, and the magnet cooperates with the magnetic field created around the magnetic field. As a result, the magnet is linearly moved forward and backward. The linear forward and backward movement of the magnet is transmitted to the piston through the magnet frame. Consequently, the piston is linearly reciprocated in the cylinder for compressing the fluid in the cylinder.

When the conventional linear compressor is operated for a long time, however, electric voltage is successively applied to the coil with the result that the coil and the bobbin are heated. The heat is transmitted to the cylinder, and thus increases the temperature of the fluid being compressed in the cylinder. As a result, compression efficiency of the fluid is lowered, and the coil and the bobbin are quickly worn. Consequently, the service life of the linear compressor is reduced.

### SUMMARY OF THE INVENTION

Therefore, the present invention has been made in view of the above problems, and it is an object of the present invention to provide a linear compressor that is capable of cooling a linear motor to prevent the linear motor from overheating, whereby compression efficiency of the linear compressor is effectively improved, and service life of the linear compressor is effectively increased.

It is another object of the present invention to provide a linear compressor that is capable of cooling a coil with oil used to lubricate or cool a piston and a cylinder through adaptation of the structure of the linear compressor such that the oil passes by the coil, whereby the structure of the linear compressor is simplified, and the manufacturing costs of the linear compressor are reduced.

In accordance with one aspect of the present invention, the above and other objects can be accomplished by the provision of a linear compressor comprising: a cylinder; a piston disposed such that the piston can be linearly reciprocated in the cylinder; a bobbin; a coil wound on the bobbin; a magnet linearly movable forward and backward by means of a magnetic force generated around the coil; a magnet frame to transmit the linear forward and backward movement of the magnet to the piston; a cooling channel disposed in contact with the bobbin; and a cooling fluid supply unit to supply a cooling fluid into the cooling channel.

Preferably, the cooling channel is a cooling pipe disposed in contact with the inner circumference of the bobbin while being wound on the bobbin in the shape of a spiral.

Preferably, the cooling fluid supply unit is a pump that pumps the cooling fluid to the cooling channel.

Preferably, the cooling fluid supply unit comprises: a pump that pumps the cooling fluid; first fluid guide holes to guide the cooling fluid pumped by means of the pump between the cylinder and the piston; and second fluid guide holes to guide the cooling fluid having passed between the cylinder and the piston to the cooling channel.

In accordance with another aspect of the present invention, there is provided a linear compressor comprising: a hermetically sealed container containing oil; a cylinder block disposed in the hermetically sealed container, the cylinder block being provided with a cylinder; a piston disposed such that the piston can be linearly reciprocated in the cylinder; a linear motor connected to the piston for linearly reciprocating the piston; a cooling channel disposed in contact with the linear motor; and an oil supply unit to supply the oil contained in the hermetically sealed container to the cooling channel.

Preferably, the linear motor comprises: a bobbin; a coil wound on the bobbin; an outer stator core that surrounds the bobbin; an inner stator core disposed such that the inner stator core is spaced apart from the outer stator core by a prescribed distance; a magnet linearly movable forward and backward by means of a magnetic force generated at the coil; and a magnet frame to transmit the linear forward and backward movement of the magnet to the piston, the cooling channel being a cooling pipe disposed in contact with the inner circumference of the bobbin.

Preferably, the oil supply unit is a pump that pumps the oil contained in the hermetically sealed container to the cooling channel.

Preferably, the oil supply unit comprises: an oil pump that pumps the oil contained in the hermetically sealed container; first oil guide holes to guide the oil pumped by means of the oil pump between the cylinder and the piston; and second oil guide holes to guide the oil having passed between the cylinder and the piston to the cooling channel.

In accordance with yet another aspect of the present invention, there is provided a linear compressor comprising: a hermetically sealed container containing oil; a cylinder block disposed in the hermetically sealed container, the cylinder block being provided with a cylinder; a piston disposed such that the piston can be linearly reciprocated in the cylinder; a linear motor connected to the piston for linearly reciprocating the piston, the linear motor including a bobbin having a coil receiving part and an oil receiving part divided from the coil receiving part by means of a partition, a coil wound on the coil receiving part, an outer stator core that surrounds the bobbin, an inner stator core disposed such that the inner stator core is spaced apart from the outer stator core by a prescribed distance, a magnet linearly movable forward and backward by means of a magnetic force generated at the coil, and a magnet frame to transmit the linear forward and backward movement of the magnet to the piston; and an oil supply unit to supply oil to the oil receiving part of the bobbin.

Preferably, the coil receiving part of the bobbin is disposed at the outer part of the bobbin in the radial direction of the bobbin, and the oil receiving part of the bobbin is disposed at the inner part of the bobbin in the radial direction of the bobbin.

Preferably, the coil receiving part of the bobbin is disposed at the inner part of the bobbin in the radial direction of the bobbin, and the oil receiving part of the bobbin is disposed at the outer part of the bobbin in the radial direction of the bobbin.

Preferably, the oil receiving part of the bobbin is provided with an oil supply channel that guides the oil supplied by means of the oil supply unit to the oil receiving part, and an oil discharge channel that discharges the oil in the oil receiving part out of the linear motor.

Preferably, the oil supply unit comprises: an oil pump that pumps the oil contained in the hermetically sealed container; and an oil pipe that guides the oil pumped by means of the oil pump to the oil supply channel.

Preferably, the oil supply unit comprises: an oil pump that pumps the oil contained in the hermetically sealed container; first oil guide holes to guide the oil pumped by means of the oil pump between the cylinder and the piston; and second oil guide holes to guide the oil having passed between the cylinder and the piston to the oil supply channel.

According to the present invention, the bobbin and the coil are cooled by means of the cooling fluid. Consequently, the present invention has an advantage that compression efficiency of the linear compressor is effectively improved, and service life of the linear compressor is effectively increased.

According to the present invention, the cooling pipe is arranged, in the shape of a spiral, on the inner circumference of the bobbin, by which a heat transfer area is increased. Consequently, the present invention has an advantage that the linear motor is quickly and efficiently cooled.

According to the present invention, the oil, which is used to cool and lubricate the piston and the cylinder, is also used to cool the linear motor. Consequently, the present invention has an advantage that the structure of the linear compressor is simplified, and thus the manufacturing costs of the linear compressor are reduced.

According to the present invention, the bobbin is provided with a coil receiving part, in which the coil is received, and an oil receiving part, in which the oil is received. Consequently, the present invention has an advantage that the size of the linear motor, and thus the size of the linear compressor can be minimized while the linear motor is effectively cooled.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view showing the inner structure of a linear compressor according to a first preferred embodiment of the present invention;

FIG. 2 is an enlarged sectional view showing main components of the linear compressor according to the first preferred embodiment of the present invention shown in FIG. 1;

FIG. 3 is a side view showing the main components of the linear compressor according to the first preferred embodiment of the present invention shown in FIG. 2;

FIG. 4 is a sectional view showing the inner structure of a linear compressor according to a second preferred embodiment of the present invention;

FIG. 5 is a sectional view showing the inner structure of a linear compressor according to a third preferred embodiment of the present invention;

FIG. 6 is a sectional view showing the inner structure of a linear compressor according to a fourth preferred embodiment of the present invention; and

FIG. 7 is a sectional view showing the inner structure of a linear compressor according to a fifth preferred embodiment of the present invention.

### DESCRIPTION OF THE PREFERRED EMBODIMENTS

Now, preferred embodiments of the present invention will be described in detail with reference to the accompanying drawings.

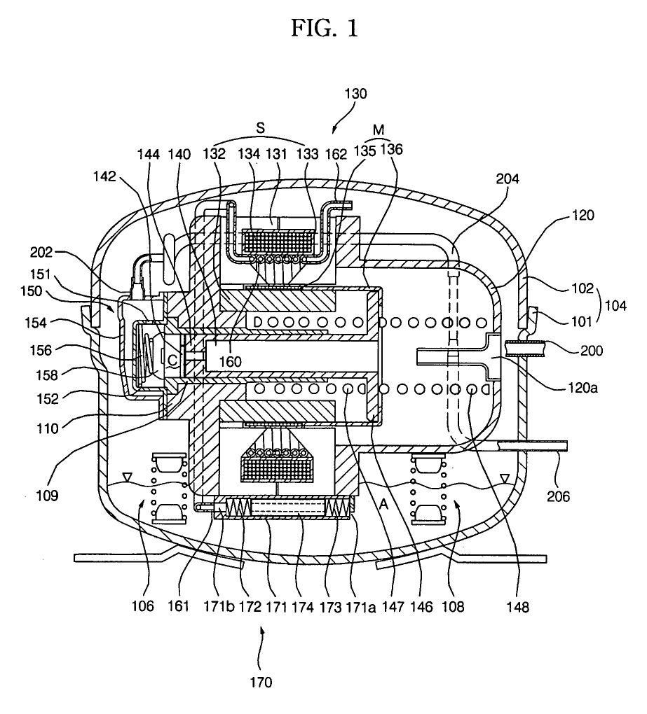

FIG. 1 is a sectional view showing the inner structure of a linear compressor according to a first preferred embodiment of the present invention.

As shown in FIG. 1, the linear compressor according to the first preferred embodiment of the present invention includes: a hermetically sealed container 104 comprising a lower container 101 and an upper cover 104, the hermetically sealed container 104 containing oil A therein; a cylinder block 110 placed on a first damper 106 mounted to one side of the hermetically sealed container 104 in the hermetically sealed container 104 in such a manner that shock applied to the cylinder block 110 is absorbed by means of the first damper 106, the cylinder block 110 having a cylinder 109 formed therein; a back cover 120 placed on a second damper 108 mounted to the other side of the hermetically sealed container 104 in the hermetically sealed container 104 in such a manner that shock applied to the back cover 120 is absorbed by means of the second damper 108, the back cover 120 having a fluid introduction hole 120a for allowing fluid to be introduced therethrough; a linear motor 130 fixedly disposed between the cylinder block 110 and the back cover 120; a piston 144 connected to the linear motor 130 such that the piston 144 can be linearly reciprocated in the cylinder 109, the piston 144 having a fluid flow channel 140 formed therein for allowing the fluid introduced through the fluid introduction hole 120a of the back cover 120 to flow into the cylinder 109, the piston 144 being provided with an inlet valve 142 for opening and closing the fluid flow channel 140; an outlet valve 150 defining a compression chamber C together with the interior of the cylinder 109 and one end of the piston 144, the outlet valve 150 being operated to open and close the compression chamber C; a cooling pipe 160 mounted such that the cooling pipe 160 contacts the linear motor 130 for cooling the linear motor 130; and a cooling fluid supply unit 170 to supply a cooling fluid into the cooling pipe 160.

The linear motor 130 comprises a stator S and a mover M. The stator S comprises: an outer laminated stator core 131; an inner laminated stator core 132 disposed such that the inner stator core 132 is spaced apart from the outer stator core 131 by a prescribed distance; a bobbin 133 attached to the outer stator core 131; and a coil 134 wound on the bobbin 133. The mover M comprises: a magnet 135 linearly movable forward and backward by means of a magnetic force generated around the coil 134; and a magnet frame 136 disposed between the outer stator core 131 and the inner stator core 132 such that the magnet frame 136 can linearly move forward and backward. The magnet 135 is fixed to the magnet frame 136. The magnet frame 136 is fixedly attached to the piston 144.

The outer stator core 131 is disposed between the cylinder block 110 and the back cover 120 while the outer stator core 131 is fixedly attached to the cylinder block 110 and the back cover 120 by means of suitable fastening members.

The inner stator core 132 is fixedly attached to the cylinder block 110 by means of suitable fastening members.

The bobbin 133 is formed in the shape of a hollow cylinder. Preferably, the bobbin 133 has a rectangular section, by which the coil wound on the bobbin 133 can be easily arranged on the bobbin 133.

The magnet frame 136 is fixedly attached to the piston 144 by means of suitable fastening members.

The inlet valve 142 is fixedly attached to one end of the piston 144 such that the fluid flow channel 140 is opened or closed by means of the inlet valve 142. A portion of the inlet valve 142, which corresponds to the fluid flow channel 140 of the piston 144, can be elastically bent.

One end of the piston 144 is inserted into the cylinder 109 while being linearly reciprocated in the cylinder 109 so that the piston 144 moves forward and backward in the cylinder 109. At the other end of the piston 144, which is not inserted in the cylinder 109, is formed a fixing part 146 protruded in the radial direction. The fixing part 146 of the piston 144 is fixed to the magnet frame 136 by means of suitable fastening members. The fixing part 146 of the piston 144 is elastically supported by means of a first spring 147 disposed between one surface of the fixing part 146 and the cylinder block 110 and a second spring 148 disposed between the other surface of the fixing part 146 and the back cover 120.

The outlet valve 150 comprises: an inner outlet cover 152 mounted to the cylinder block 110 while communicating with the cylinder 109 and having a fluid outlet hole 151 formed at one side thereof; an outer outlet cover 154 disposed outside the inner outlet cover 152 while being spaced apart from the inner outlet cover 152; and a valve body 158 elastically supported by means of a spring 156 in the inner outlet cover 152 for opening or closing the cylinder 109.

The cooling pipe 160 is in contact with the inner or outer circumference of the bobbin 133.

Also, the cooling pipe 160 is disposed such that one end 161 of the cooling pipe 160 communicates with the cooling fluid supply unit 170, and the other end 162 of the cooling pipe 169 extends out of the linear motor 130.

Preferably, the cooling fluid supply unit 170 is an oil pump that supplies oil contained in the hermetically sealed container 104 into the cooling pipe 160.

The oil pump 170 comprises: a pump case 171 mounted below the cylinder block 110, the back cover 120, and the linear motor 130, the pump case 171 having an oil inlet hole 171a formed at one end thereof, an oil outlet hole 171b formed at the other end thereof such that the oil outlet hole 171b communicates with the end 161 of the cooling pipe 160, and an oil channel formed therein; and a pump piston 174 having both ends elastically supported by means of springs 172 and 173 in the oil channel of the pump case 171, the pump piston 174 being provided with an oil flow channel formed in the longitudinal direction thereof. When the cylinder block 110, the back cover 120, and the linear motor 130 are operated, the pump piston 174 is linearly reciprocated in the pump case 171 for introducing oil through the oil inlet hole 171a and discharging the oil through the oil outlet hole 171b.

Unexplained reference numeral 200 indicates an inlet connection pipe connected to the hermetically sealed container 104 for allowing fluid to be introduced into the hermetically sealed container 104 therethrough, unexplained reference numeral 202 indicates an outlet pipe connected to the outer outlet cover 154 of the outlet valve 150 for allowing the fluid having passed through the outlet valve 150 to be discharged therethrough, unexplained reference numeral 204 indicates a loop pipe having one end connected to the outlet pipe 202, and unexplained reference numeral 206 indicates an outlet connection pipe having one end connected to the loop pipe 204. The outlet connection pipe 206 penetrates the hermetically sealed container 104 and then extends out of the hermetically sealed container 104.

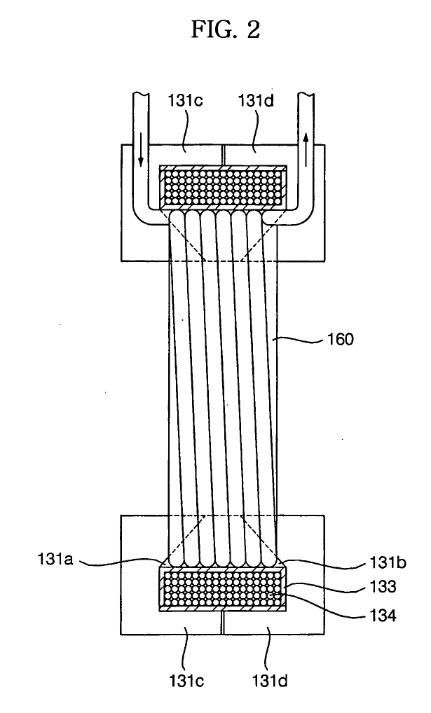

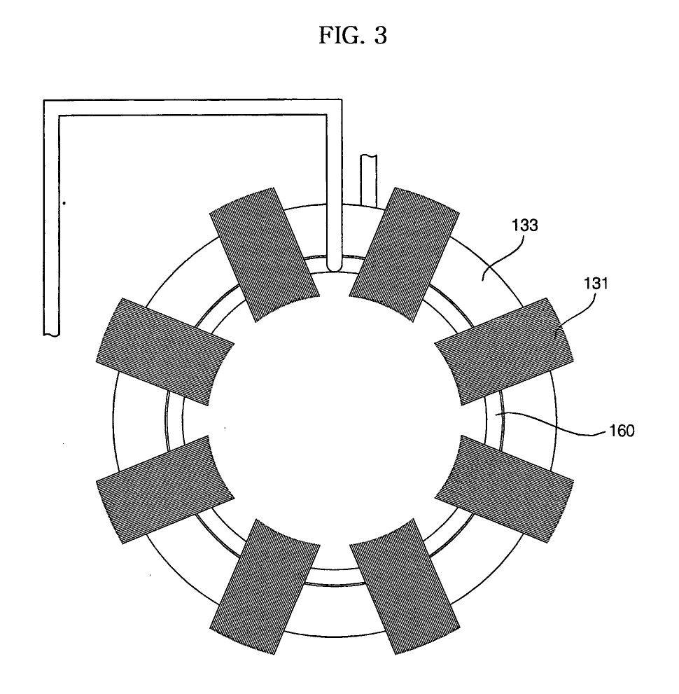

FIG. 2 is an enlarged sectional view showing main components of the linear compressor according to the first preferred embodiment of the present invention shown in FIG. 1, and FIG. 3 is a side view showing the main components of the linear compressor according to the first preferred embodiment of the present invention shown in FIG. 2.

As shown in FIGS. 2 and 3, the outer stator core 131 comprises a plurality of outer stator core parts disposed on the bobbin 133 such that the outer stator core parts are spaced apart from each other in the circumferential direction thereof. Each of the outer stator core parts comprises core blocks 131c and 131d, which are separable such that the core blocks 131 and 131d partially surround the bobbin 133 on which the coil 134 is wound. The core blocks 131c and 131d have receiving grooves 131a and 131b, in which the bobbin 133 is partially received, respectively. The core blocks 131c and 131d are connected to each other such that the receiving groove 131a of the core block 131c is opposite to the receiving groove 131b of the core block 131d.

The cooling pipe 160 is disposed through the receiving grooves 131a and 131b along with the bobbin 133 having the coil 134 wound thereon. Preferably, the cooling pipe 160 is arranged in the shape of a spiral such that the cooling pipe 160 can broadly contact the inner or outer circumference of the bobbin 133.

The operation of the linear compressor with the above-stated construction according to the first preferred embodiment of the present invention will now be described.

When electric voltage is applied to the coil 134, a magnetic field is created around the coil 134, and the magnet 135 cooperates with the magnetic field created around the coil 134. As a result, the magnet 135 is linearly moved forward and backward. The linear forward and backward movement of the magnet 135 is transmitted to the piston 144 via the magnet frame 136. Consequently, the piston 144 is linearly moved forward and backward in the cylinder 109 for compressing a fluid in the cylinder 109.

At this time, the inlet valve 142 and the outlet valve 150 are opened and closed due to flow of the fluid caused by means of the linear forward and backward movement of the piston 144, and the fluid is introduced into the hermetically sealed container 104 through the inlet connection pipe 200. The fluid introduced into the hermetically sealed container 104 is guided into the compression chamber C through the fluid introduction hole 120a of the back cover 120 and the fluid flow channel 140 of the piston 144.

The fluid guided into the compression chamber C is compressed by means of the piston 144. The compressed fluid is discharged through the outlet valve 150, the outlet pipe 202, the loop pipe 204 and the outlet connection pipe 206 in turn.

While the piston 144 is linearly moved forward and backward, and the fluid is introduced, compressed, and discharged by the linear forward and backward movement of the piston 144, the oil pump 170 pumps oil from the hermetically sealed container 104 to one end of the cooling pipe 160. The pumped oil cools the bobbin 133 and the coil 134 while passing through the cooling pipe 160, and is then introduced into the hermetically sealed container 104 through the other end of the cooling pipe 160. The oil is collected in the lower part of the hermetically sealed container 104.

It should be noted that the present invention is not limited to the first embodiment as described above. For example, the cooling fluid supply unit may be a pump or a blower disposed outside the linear compressor. In this case, additional coolant or cool air is externally supplied to the cooling pipe 160.

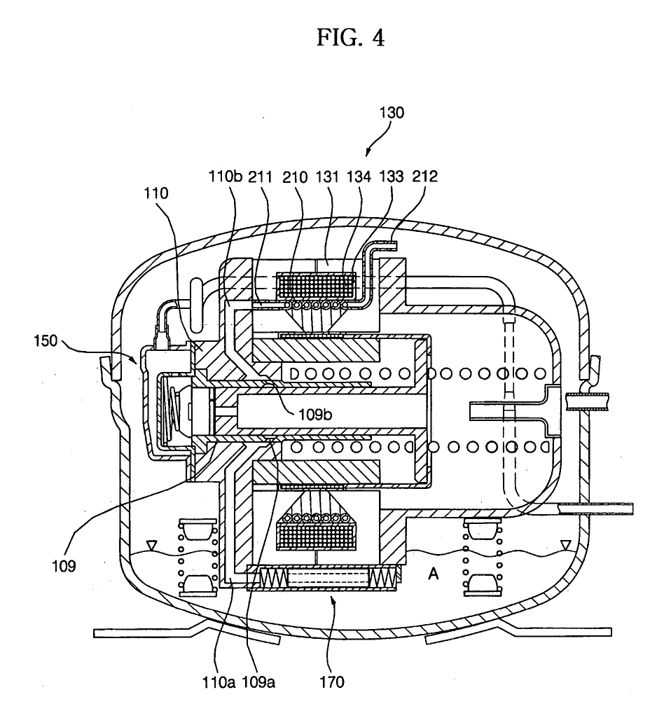

FIG. 4 is a sectional view showing the inner structure of a linear compressor according to a second preferred embodiment of the present invention.

The linear compressor according to the second preferred embodiment of the present invention is identical to the linear compressor according to the previously described first preferred embodiment of the present invention in terms of construction and operation except that the oil pumped by means of the oil pump 170 is used to cool and lubricate the piston 144 and the cylinder 109, and is then used to cool the linear motor 130. Therefore, elements of the linear compressor according to the second preferred embodiment of the present invention, which correspond to those of the linear compressor according to the first preferred embodiment of the present invention, are indicated by the same reference numerals as those of the linear compressor according to the first preferred embodiment of the present invention, and a detailed description thereof will not be given.

As shown in FIG. 4, the cylinder 109 is provided with a first oil guide hole 109a, and the cylinder block 110 is provided with another first oil guide hole 110a. The first oil guide hole 109a of the cylinder 109 communicates with the first oil guide hole 110a of the cylinder block 110 such that the oil pumped by means of the oil pump 170 can be guided between the cylinder 109 and the piston 144.

Also, the cylinder 109 is provided with a second oil guide hole 109b, and the cylinder block 110 is provided with another second oil guide hole 110b. The second oil guide hole 109b of the cylinder 109 communicates with the second oil guide hole 110b of the cylinder block 110 such that the oil having passed between the cylinder 109 and the piston 144 can be guided to the linear motor 130.

To the end of the second oil guide hole 110b of the cylinder block 110 is connected a cooling pipe 210, which is in contact with the inner circumference of the bobbin 133 of the linear motor 130.

The cooling pipe 210 has one end 211 communicating with the second oil guide hole 110b of the cylinder block 110 and the other end 212 extending out of the linear motor 130. The cooling pipe 210 is disposed through the receiving grooves 131a and 131b of the outer stator 131 in the shape of a spiral, as in the first preferred embodiment of the present invention.

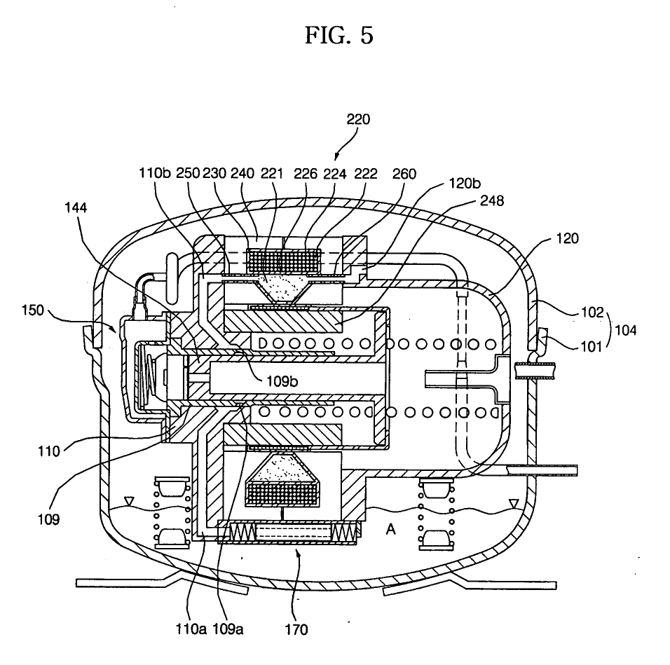

FIG. 5 is a sectional view showing the inner structure of a linear compressor according to a third preferred embodiment of the present invention.

The linear compressor according to the third preferred embodiment of the present invention is identical to the linear compressors according to the previously described first and second preferred embodiments of the present invention in terms of construction and operation except that a linear motor 220 is provided at the inside thereof with an additional oil receiving part 221, and thus oil supplied by means of the oil supply unit cools the linear motor 220 while passing through the oil receiving part 221. Therefore, elements of the linear compressor according to the third preferred embodiment of the present invention, which correspond to those of the linear compressors according to the first and second preferred embodiments of the present invention, are indicated by the same reference numerals as those of the linear compressors according to the first and second preferred embodiments of the present invention, and a detailed description thereof will not be given.

As shown in FIG. 5, the linear motor 220 includes: a coil 222; a bobbin 230 having a coil receiving part 224 and an oil receiving part 221 divided from the coil receiving part 224 by means of a partition 226; an outer stator core 240 comprising a plurality of outer stator core parts having receiving grooves, in which the bobbin 230 is partially received, respectively; and an inner stator core 248 disposed such that the inner stator core 248 is spaced a predetermined distance from the outer stator core 240.

The oil receiving part 221 of the bobbin 230 is disposed above the partition 226 in the radial direction of the bobbin 230, and the coil receiving part 224 of the bobbin 230 is disposed below the partition 226 in the radial direction of the bobbin 230. In other words, the oil receiving part 221 of the bobbin 230 is disposed around the coil receiving part 224 of the bobbin 230 in the radial direction of the bobbin 230.

The oil receiving part 221 of the bobbin 230 is inclined at both sides in the longitudinal direction thereof such that the oil receiving part 221 corresponds to the receiving grooves of the outer stator core 240.

The coil receiving part 221 of the bobbin 230 has a rectangular section, by which the coil 222 can be easily arranged on the bobbin 230.

The bobbin 230 is provided with an oil supply channel 250 that guides the oil supplied by means of the oil supply unit to the oil receiving part 221, and an oil discharge channel 260 that discharges the oil having passed through the oil receiving part 221 out of the linear motor 220.

The oil supply channel 250 is a pipe having one end communicating with the oil supply unit and the other end communicating with the oil receiving part 221.

The oil discharge channel 260 is a pipe having one end communicating with the oil receiving part 221 and the other end communicating with an oil discharge hole 120b formed at the back cover 120.

The oil supply unit is constructed such that the oil contained in the hermetically sealed container 104 is used to cool and lubricate the piston 144 and the cylinder 109, and is then used to cool the linear motor, as in the second preferred embodiment of the present invention as described above.

The oil supply unit comprises: an oil pump 170 disposed such that the oil pump 170 is submerged under the oil contained in the hermetically sealed container 104; first oil guide holes 110a and 109a formed at the cylinder block 110 and the cylinder 109, respectively, the first oil guide hole 109a of the cylinder 109 communicating with the first oil guide hole 110a of the cylinder block 110 such that the oil pumped by means of the oil pump 170 can be guided between the cylinder 109 and the piston 144; and second oil guide holes 110b and 109b formed at the cylinder block 110 and the cylinder 109, respectively, the second oil guide hole 109b of the cylinder 109 communicating with the second oil guide hole 110b of the cylinder block 110 such that the oil having passed between the cylinder 109 and the piston 144 can be guided to the oil supply channel 250 of the bobbin 230.

In this embodiment of the present invention, the remaining spaces of the receiving grooves of the outer stator core 240 are used as the oil receiving part 221. Consequently, the size of the linear motor 220, and thus the size of the linear compressor can be minimized while the linear motor 220 is effectively cooled.

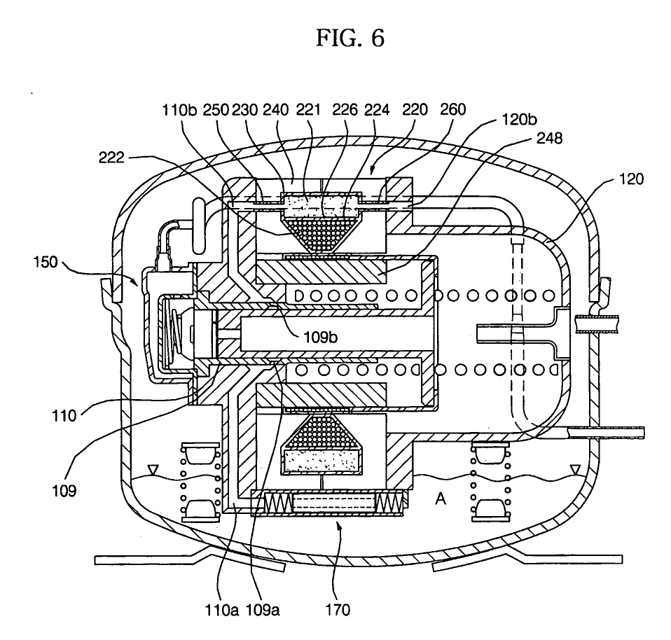

FIG. 6 is a sectional view showing the inner structure of a linear compressor according to a fourth preferred embodiment of the present invention.

The linear compressor according to the fourth preferred embodiment of the present invention is identical to the linear compressors according to the previously described third preferred embodiment of the present invention in terms of construction and operation except that the coil receiving part 224 of the bobbin 230 is disposed above the partition 226 in the radial direction of the bobbin 230, and the oil receiving part 221 of the bobbin 230 is disposed below the partition 226 in the radial direction of the bobbin 230, and that the coil receiving part 224 of the bobbin 230 is inclined at both sides in the longitudinal direction thereof such that the coil receiving part 224 corresponds to the receiving grooves of the outer stator core 240, and the oil receiving part 221 of the bobbin 230 has a rectangular section. Therefore, elements of the linear compressor according to the fourth preferred embodiment of the present invention, which correspond to those of the linear compressor according to the third preferred embodiment of the present invention, are indicated by the same reference numerals as those of the linear compressor according to the third preferred embodiment of the present invention, and a detailed description thereof will not be given.

In this embodiment of the present invention, the linear motor is effectively cooled while the inner space of the linear motor is maximally used, as in the third preferred embodiment of the present invention.

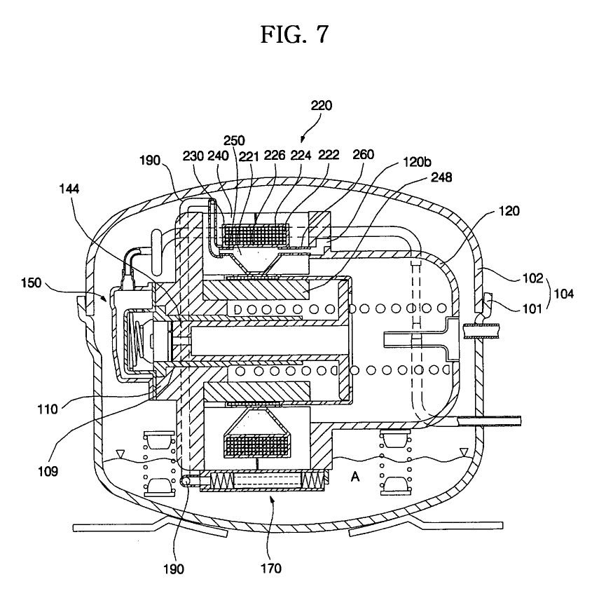

FIG. 7 is a sectional view showing the inner structure of a linear compressor according to a fifth preferred embodiment of the present invention.

As shown in FIG. 7, the oil supply unit is constructed such that the oil contained in the hermetically sealed container 104 can be directly supplied to the oil supply channel 250 of the bobbin 230.

The oil supply unit comprises: an oil pump 170 disposed such that the oil pump 170 is submerged under the oil contained in the hermetically sealed container 104; and an oil pipe 190 having one end connected to the oil pump 170 and the other end connected to the oil supply channel 250 of the bobbin 230.

Other construction and operation of the linear compressor according to the fifth preferred embodiment of the present invention are identical to those of the linear compressor according to the previously described third and fourth preferred embodiments of the present invention. Therefore, elements of the linear compressor according to the fifth preferred embodiment of the present invention, which correspond to those of the linear compressors according to the third and fourth preferred embodiments of the present invention, are indicated by the same reference numerals as those of the linear compressors according to the third and fourth preferred embodiments of the present invention, and a detailed description thereof will not be given.

As apparent from the above description, the present invention provides a linear compressor having a cooling pipe disposed such that the cooling pipe is in contact with a bobbin on which a coil is wound, and a cooling fluid supply unit to supply a cooling fluid to the cooling pipe such that the bobbin and the coil are cooled by means of the cooling fluid. Consequently, the present invention has the effect that compression efficiency of the linear compressor is effectively improved, and service life of the linear compressor is effectively increased.

According to the present invention, the cooling pipe is arranged, in the shape of a spiral, on the inner circumference of the bobbin, by which a heat transfer area is increased. Consequently, the present invention has the effect that the linear motor is quickly and efficiently cooled.

According to the present invention, the oil, which is used to cool and lubricate the piston and the cylinder, is also used to cool the linear motor. Consequently, the present invention has the effect that the structure of the linear compressor is simplified, and thus the manufacturing costs of the linear compressor are reduced.

According to the present invention, the bobbin is provided with a coil receiving part, in which the coil is received, and an oil receiving part, in which the oil is received. Consequently, the present invention has the effect that the size of the linear motor, and thus the size of the linear compressor can be minimized while the linear motor is effectively cooled.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A linear compressor comprising:
a cylinder;
a piston disposed such that the piston can be linearly reciprocated in the cylinder;
a bobbin;
a coil wound on the bobbin;
a magnet linearly movable by means of a magnetic force generated around the coil;
a magnet frame to transmit the linear movement of the magnet to the piston;
a cooling channel disposed in contact with the bobbin; and
a cooling fluid supply unit to supply a cooling fluid into the cooling channel.

2. The compressor as set forth in claim 1, wherein the cooling channel is a cooling pipe disposed in contact with the inner circumference of the bobbin.

3. The compressor as set forth in claim 2, wherein the cooling pipe is wound in the shape of a spiral.

4. The compressor as set forth in claim 1, wherein the cooling fluid supply unit is a pump that pumps the cooling fluid to the cooling channel.

5. The compressor as set forth in claim 1, wherein the cooling fluid supply unit comprises:
a pump that supplies the cooling fluid;
first fluid guide holes to guide the cooling fluid pumped by means of the pump between the cylinder and the piston; and
second fluid guide holes to guide the cooling fluid having passed between the cylinder and the piston to the cooling channel.

6. A linear compressor comprising:
a hermetically sealed container containing oil;
a cylinder block disposed in the hermetically sealed container, the cylinder block being provided with a cylinder;
a piston disposed such that the piston can be linearly reciprocated in the cylinder;
a linear motor connected to the piston for linearly reciprocating the piston;
a cooling channel disposed in contact with the linear motor; and
an oil supply unit to supply the oil contained in the hermetically sealed container to the cooling channel.

7. The compressor as set forth in claim 6, wherein the linear motor comprises:
a bobbin;
a coil wound on the bobbin;
an outer stator core that surrounds the bobbin;
a magnet linearly movable forward and backward by means of a magnetic force generated at the coil; and
a magnet frame to transmit the linear forward and backward movement of the magnet to the piston, and
wherein the cooling channel is a cooling pipe disposed in contact with the inner circumference of the bobbin.

8. The compressor as set forth in claim 7, wherein the cooling pipe is wound in the shape of a spiral.

9. The compressor as set forth in claim 6, wherein the oil supply unit is a pump that supplies the oil contained in the hermetically sealed container to the cooling channel.

10. The compressor as set forth in claim 6, wherein the oil supply unit comprises:
an oil pump that pumps the oil contained in the hermetically sealed container;
first oil guide holes to guide the oil pumped by means of the oil pump between the cylinder and the piston; and
second oil guide holes to guide the oil having passed between the cylinder and the piston to the cooling channel.

11. The compressor as set forth in claim 10, wherein the first oil guide holes are formed at the cylinder block and the cylinder, respectively, the first oil guide hole of the cylinder communicating with the first oil guide hole of the cylinder block such that the oil pumped by means of the oil pump successively passes through the cylinder block and the cylinder, and is then guided between the cylinder and the piston.

12. The compressor as set forth in claim 10, wherein the second oil guide holes are formed at the cylinder and the cylinder block, respectively, the second oil guide hole of the cylinder communicating with the second oil guide hole of the cylinder block such that the oil between the cylinder and the piston successively passes through the cylinder and the cylinder block, and is then guided to the oil receiving part of the bobbin.

13. A linear compressor comprising:
a hermetically sealed container containing oil;
a cylinder block disposed in the hermetically sealed container, the cylinder block being provided with a cylinder;
a piston disposed such that the piston can be linearly reciprocated in the cylinder;
a linear motor connected to the piston for linearly reciprocating the piston, the linear motor including
a bobbin having a coil receiving part and an oil receiving part divided from the coil receiving part by means of a partition,
a coil wound on the coil receiving part,
an outer stator core that surrounds the bobbin,
a magnet linearly movable forward and backward by means of a magnetic force generated at the coil, and
a magnet frame to transmit the linear forward and backward movement of the magnet to the piston; and
an oil supply unit to supply oil to the oil receiving part of the bobbin.

14. The compressor as set forth in claim 13, wherein
the coil receiving part of the bobbin is disposed at the outer part of the bobbin in the radial direction of the bobbin, and
the oil receiving part of the bobbin is disposed at the inner part of the bobbin in the radial direction of the bobbin.

15. The compressor as set forth in claim 13, wherein
the coil receiving part of the bobbin is disposed at the inner part of the bobbin in the radial direction of the bobbin, and
the oil receiving part of the bobbin is disposed at the outer part of the bobbin in the radial direction of the bobbin.

16. The compressor as set forth in claim 13, wherein the oil receiving part of the bobbin is provided with
an oil supply channel that guides the oil supplied by means of the oil supply unit to the oil receiving part, and
an oil discharge channel that discharges the oil in the oil receiving part out of the linear motor.

17. The compressor as set forth in claim 16, wherein the oil supply unit comprises:
an oil pump that pumps the oil contained in the hermetically sealed container; and
an oil pipe that guides the oil pumped by means of the oil pump to the oil supply channel.

18. The compressor as set forth in claim 16, wherein the oil supply unit comprises:
an oil pump that pumps the oil contained in the hermetically sealed container;
first oil guide holes to guide the oil pumped by means of the oil pump between the cylinder and the piston; and
second oil guide holes to guide the oil having passed between the cylinder and the piston to the oil supply channel.

19. The compressor as set forth in claim 18, wherein the first oil guide holes are formed at the cylinder block and the cylinder, respectively, the first oil guide hole of the cylinder communicating with the first oil guide hole of the cylinder block such that the oil pumped by means of the oil pump successively passes through the cylinder block and the cylinder, and is then guided between the cylinder and the piston.

20. The compressor as set forth in claim 18, wherein the second oil guide holes are formed at the cylinder and the cylinder block, respectively, the second oil guide hole of the cylinder communicating with the second oil guide hole of the cylinder block such that the oil between the cylinder and the piston successively passes through the cylinder and the cylinder block, and is then guided to the oil receiving part of the bobbin.
